(19) United States
(12) Patent Application Publication
(10) Pub. No.: US 2026/0249828 A1
(43) Pub. Date: Aug. 27, 2026

(54) BRAKING SYSTEM WITH IMPROVED ROBUSTNESS AND MECHANICAL STRENGTH

(71) Applicant: HITACHI ASTEMO FRANCE, Drancy (FR)

(72) Inventors: Philippe BOURLON, DAMMARTIN EN GOELE (FR); Rodrigue TRAMIS, VAUX-LE-PESNIL (FR)

(21) Appl. No.: 18/871,196

(22) PCT Filed: May 25, 2023
(86) PCT No.: PCT/EP2023/064087

§ 371 Date: Dec. 3, 2024

(30) Foreign Application Priority Data
Jun. 6, 2022 (FR) FR2205410

(51) Int. Cl. B60T 13/74; B60T 1/06

(52) U.S. Cl. CPC B60T 13/746; B60T 1/065

(57) ABSTRACT

A clamping device for a braking system intended to exert a relative displacement between friction elements with the aid of an electric actuator having a mechanism for converting the rotational movement of an output shaft of the electric actuator into a translational movement of the ball-screw type having a nut coupled to a screw by balls, and a mechanism for radial and/or tangential decoupling of a stop, intended to receive a friction element, with respect to a free end of the screw of the conversion mechanism in order to improve the mechanical strength of the latter.

### TECHNICAL FIELD OF THE INVENTION

The invention relates to the field of braking systems for vehicles, more particularly of braking systems of the electromechanical type.

### TECHNICAL BACKGROUND

A braking system for a vehicle, in particular a motor vehicle, generally comprises mechanical clamping devices comprising in particular friction elements, such as brake pads, connected to an actuator adapted to move a pair of these friction elements towards two opposite sides of a disc attached to a wheel of the vehicle to clamp it and thus brake the vehicle by friction of the friction elements against the disc, or move them away in order to stop braking.

In the case of braking systems of the electromechanical type, the mechanical clamping devices comprise at least one electric actuator such as a motor provided with a rotating output shaft. Consequently, these mechanical clamping devices of the electromechanical type must have a mechanism for converting the rotational movement of the output shaft of the electric actuator into a translational movement necessary to move the friction elements towards each other, which makes them more complicated than those of the hydraulic type.

In addition, as the braking system is used, the friction elements wear out due to friction against the disc. We therefore understand that the stroke of the conversion mechanism must take into account this variation in distance with increasing wear, in other words the reduction in thickness, of the friction elements.

Lastly, during the friction, a high tangential stress is induced by the moving disc against the friction elements imposed in particular by the vehicle inertia. The end of the conversion mechanism must therefore also be designed in order to guarantee resistance to the fatigue generated by these repeated tangential stresses.

### SUMMARY OF THE INVENTION

The invention aims in particular to propose a clamping device for a braking system guaranteeing reversible movements for clamping and unclamping the disc by the friction elements which are reliable, in other words in particular whose axial stress exerted by the end of the conversion mechanism is oriented reproducibly in the two directions of movement, but which are also robust, in other words whose lifetime is compatible with that of the vehicle without malfunction.

Thus, the invention relates to a clamping device for a braking system intended to exert a relative displacement between friction elements and having a frame supporting an electric actuator intended to supply the clamping force and a mechanism for converting the rotational movement of an output shaft of the electric actuator into a translational movement which is coupled to the electric actuator to allow the relative displacement movement between the friction elements along an axial rectilinear direction, characterised in that the conversion mechanism is of the ball-screw type having a nut coupled to a screw by balls and in that the clamping device comprises a mechanism for radial and/or tangential decoupling of a stop intended to receive a friction element with respect to a free end of the screw of the conversion mechanism in order to improve the mechanical strength of the latter.

Advantageously according to the invention, by using point connections with balls, the conversion mechanism reduces the friction between the screw and the nut. We therefore understand that there will be little impact on the efficiency of the force transmitted by the electric actuator, in other words little force will be absorbed by the conversion mechanism. In addition, the screw is displaced with highly precise movements and with negligible wear of the surfaces. Lastly, the rotational movement of the output shaft of the electric actuator converted into a translational movement is fully reversible between a position in which the friction elements are moved towards each other, called the position in contact with the disc, and a position in which the friction elements are moved away from each other, called the rest position in which the friction elements do not touch the disc, thus guaranteeing very high reliability.

In addition, the decoupling mechanism allows the stop to travel a predetermined distance with respect to the end of the screw in order to limit the stresses likely to cause brinelling of the thread of the screw and/or of the outer surface of at least one ball and/or the tapping of the nut. Thus, in the contact position of the friction elements where the screw of the conversion mechanism projects fully out of the frame, any stress directed away from the axial direction of the clamping-unclamping movement generates an eccentric moment along the entire length of the screw increasing said stress, by the lever arm phenomenon, of the end of the screw closest to the electric actuator against the balls and the nut. This is all the more true when the friction elements are highly worn.

Advantageously according to the invention, the radial and/or tangential decoupling mechanism decreases or even eliminates any lever arm phenomenon and compensates for any eccentric moment by displacement of the stop with respect to the screw so as to only transmit a negligible proportion of non-axial stresses to the balls and to the nut of the conversion mechanism. We therefore understand that the brinelling and more generally the deformation of the members of the conversion mechanism are avoided to guarantee high robustness, in other words in particular to avoid having to replace the clamping device during at least the lifetime of the vehicle.

The invention comprises as a variant one or more of the following optional characteristics, taken alone or in combination.

The radial and/or tangential decoupling mechanism comprises a cylindrical joint connection element between the stop and the free end of the screw to limit the transmission, to the balls of the conversion mechanism, of the radial and/or tangential stresses received by the stop. We therefore understand that it is preferable to have one first degree of freedom in translation along a tangential direction (perpendicular to the axial direction and substantially parallel to the contact surfaces of the braking disc) and one degree of freedom in rotation about the same tangential direction to allow to a certain extent the stop to “follow” the stress tangential direction of contact between the disc and the friction element by limiting the non-axial transmission of stresses to the conversion mechanism.

The cylindrical joint connection element comprises a body having a first end which cooperates with a seat of the stop and having a second end which is interlocked with clearance fit in the free end of the screw. It is therefore this part coupled to the stop which will bear most of the non-axial stresses between the disc and the friction element.

The first end of the cylindrical joint connection element has a partially spherical contact surface intended to rest against the bottom of the seat of the stop, the bottom having a partially cylindrical concave surface of circular section oriented to allow a tangential translation of the stop with respect to the cylindrical joint connection element.

The first end of the cylindrical joint connection element is blocked in the seat of the stop using a flange in order to limit the travel of the tangential translation of the stop with respect to the cylindrical joint connection element and only allow rotation about the tangential translation axis of the stop with respect to the cylindrical joint connection element.

The decoupling mechanism is arranged to allow a tangential translation up to two millimetres of the stop with respect to the cylindrical joint connection element and a rotation about the tangential translation axis up to two degrees of the stop with respect to the cylindrical joint connection element. Similarly, the decoupling mechanism is arranged so that the interlocking with clearance fit of the second end in the free end of the screw allows a rotation about a tangential direction up to two degrees of the cylindrical joint connection element with respect to the free end of the screw.

The inner wall of the seat of the stop is asymmetrical and has a shape complementary to the peripheral wall of the first end of the cylindrical joint connection element to prevent the relative rotation between the stop and the cylindrical joint connection element about the axial direction. We can in particular imagine at least one tangential direction flat present on the inner wall of the seat coupled with at least another tangential direction flat present on the peripheral wall of the first end to prevent any rotation about the axial clamping/unclamping axial direction. Obviously, a polygonal section of the inner wall of the seat having a shape corresponding to that of the peripheral wall of the first end produces a similar effect.

The interlocking between the second end of the cylindrical joint connection element and the free end of the screw has an asymmetrical shape to prevent the relative rotation between the free end of the screw and the cylindrical joint connection element about the axial direction. We can in particular imagine an inner wall of the free end of the screw having a polygonal section coupled to the peripheral wall of the second end with a polygonal section of complementary shape to prevent any rotation about the axial clamping/unclamping direction. Obviously, an elliptical section of the inner wall of the free end of the screw having a shape complementary to that of the peripheral wall of the second end produces a similar effect.

The invention also relates to a braking system for a vehicle comprising a pair of friction elements intended to cooperate by friction with a disc, characterised in that it comprises a clamping device as described above arranged to move the pair of friction elements towards two opposite sides of the disc in order to clamp it. The braking system is preferably of the floating calliper disc brake type.

Lastly, the invention relates to a vehicle characterised in that it comprises a braking system as described above.

### BRIEF DESCRIPTION OF THE FIGURES

Other features and advantages of the invention will appear clearly on reading the description which follows, given by way of example and not limiting in any way, referring to the attached drawings, in which:

FIG. 1 is a schematic plan view of an example of a vehicle in which a braking system according to the invention is mounted;

FIG. 2 is a schematic view of an example of a braking system according to the invention;

FIG. 3 is a perspective view of an example of a clamping device according to the invention;

FIG. 4 is a partial cross-sectional view along plane IV-IV of FIG. 3;

FIG. 5 is an exploded view of an example of a decoupling mechanism according to the invention;

FIG. 6 is a perspective view of the example of the decoupling mechanism according to the invention;

FIG. 7 is an enlarged perspective view of the free end of a screw of the example of a conversion mechanism according to the invention;

FIG. 8 is a front view of a flange of the example of a decoupling mechanism according to the invention;

FIG. 9 is a cross-sectional view of the example of a decoupling mechanism according to the invention along the plane IV-IV of FIG. 3;

FIG. 10 is a cross-sectional view of the example of a decoupling mechanism according to the invention along the plane X-X of FIG. 6.

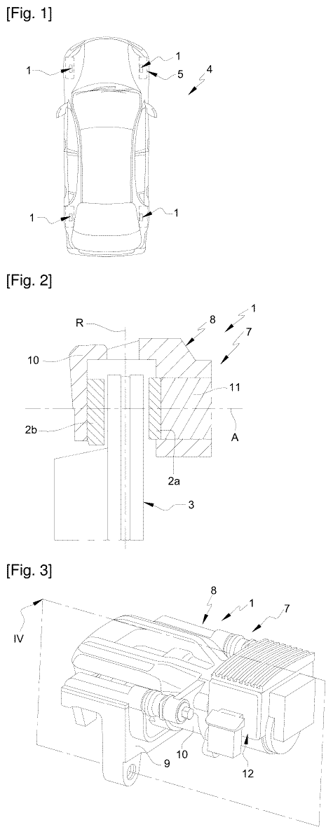

### DETAILED DESCRIPTION

In the remainder of the document, the orientations are the orientations of the figures. In particular, the terms “upper”, “lower”, “left”, “right”, “above”, “below”, “forward” and “backward” generally mean with respect to the direction of representation of the figures. However, we also mention:
an axial direction A, coinciding with the central thrust axis of the friction elements 2a, 2b;
a radial direction R, perpendicular to the axial direction A, passing through a radius in the median plane of the disc 3; and
a tangential direction T, perpendicular to the axial direction A, resulting from the friction by the friction elements 2a, 2b moving towards each other along the axial direction A pressing against the disc 3 rotating about an axis parallel to the axial direction A and attached to a wheel 5 of a vehicle 4.

The invention applies to all types of braking system 1, in particular those intended to be fitted on motor vehicles 4 such as private vehicles, SUVs (“Sport Utility Vehicles”), two-wheeled vehicles (in particular motorcycles), aeroplanes, industrial vehicles selected from vans, “heavy goods vehicles”—in other words metro, bus, road transport vehicles (trucks, tractors, trailers), off-road vehicles such as agricultural or civil engineering vehicles—, or other transport or handling vehicles. The invention also applies to non-motorised vehicles such as in particular a trailer, a semi-trailer or a caravan.

“Braking system 1 of the electromechanical type” means all types of braking system 1 comprising at least one electric actuator 12 intended to move friction elements 2a, 2b towards each other in order to clamp the sides of a disc 3 integral in rotation with a wheel 5 of a vehicle 4 to brake it.

In the examples of FIGS. 2 to 3, a braking system 1 with a floating calliper type clamping device 7 is used, in other words a frame 8, or brake, comprises an electric actuator 12 on one side only and consists of a carrier 9 fixed relative to the vehicle 4 and a calliper 10 movable relative to the carrier 9 arranged to move the friction element 2b towards the friction element 2a when the latter is in contact with the disc 3. Such a floating calliper type clamping device 7 requires the use of fewer electric actuators 12 and is therefore more compact.

Obviously, the invention also applies to a braking system 1 with a fixed calliper type clamping device 7, in other words a frame 8, consisting of a calliper 10 fixed relative to the vehicle 4, comprises one electric actuator 12 for each element 2a, 2b on each side of the disc 3 to move the friction elements 2a, 2b respectively towards each other in order to come into contact with the disc 3.

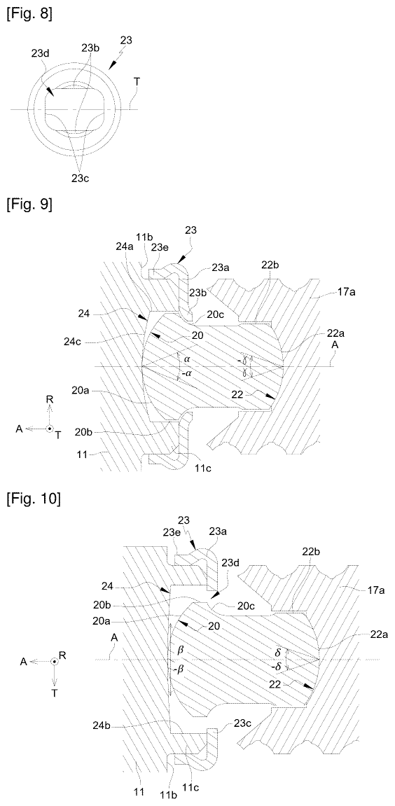

In the example shown on FIGS. 2 to 10, the invention relates to a clamping device 7 intended to exert a relative displacement along the axial direction A between friction elements 2a, 2b. A stop 11 is intended to receive a friction element 2a, 2b, such as at least one brake pad, like a hydraulic system piston. The stop 11 comprises at least one groove 11a in order to cooperate with the friction element 2a, 2b without the possibility of any rotation about the axial direction A either directly (no intermediate part such as for example an outer rib of the friction element 2a, 2b) or indirectly (intermediate part used such as for example a key between the friction element 2a, 2b and the stop 11).

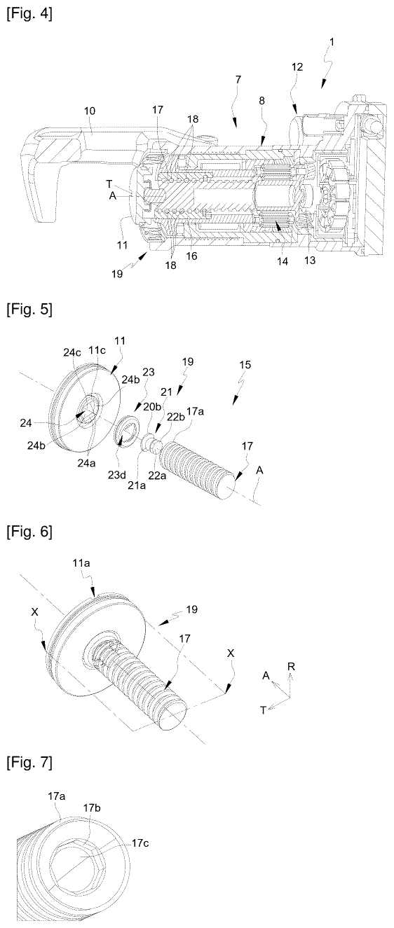

The clamping device 7 comprises a frame 8 supporting an electric actuator 12 intended to supply the clamping force by the stop 11 and all the associated power and control members in order, in particular, to manage the clamping amplitude and force. The frame 8 also receives a mechanism 15 for converting the rotational movement of an output shaft 13 of the electric actuator 12 into a translational movement along the axial direction A. In the example shown on FIG. 4, the conversion mechanism 15 is coupled to the electric actuator 12 using a reduction gear 14. A relative displacement movement is therefore obtained between the friction elements 2a, 2b along a substantially axial rectilinear direction A.

Advantageously according to the invention, the conversion mechanism 15 is of the ball-screw type. The conversion mechanism 15 mainly comprises a nut 16, a screw 17 and balls 18. The free end 17a of the screw 17 is displaced by translation along the axial direction A by means of the outer thread of the screw 17 which is coupled to the tapping of the nut 16 by balls 18. The rotation of the nut 16 is controlled when the output shaft 13 of the electric actuator 12 undergoes a rotation. The worm screw 17 is also driven in rotation by guiding of the balls 18 in the nut 16 thereby generating a translational displacement of the free end 17a of the screw 17 with respect to the frame 8 along the axial direction A.

Advantageously according to the invention, by using point connections with balls 18, the conversion mechanism 15 reduces the friction between the screw 17 and the nut 16. We therefore understand that there will be little impact on the efficiency of the force transmitted by the electric actuator 12, in other words little force will be absorbed by the conversion mechanism 15. In addition, the screw 17 is displaced with highly precise movements and with negligible wear of the surfaces. Lastly, the rotational movement of the output shaft 13 of the electric actuator 12 converted into a translational movement along the axial direction A is fully reversible between a position in which the friction elements 2a, 2b are moved towards each other, called the position in contact with the disc 3, and a position in which the friction elements 2a, 2b are moved away from each other, called the rest position in which the friction elements 2a, 2b do not touch the disc 3 shown on FIG. 2, thus guaranteeing very high reliability. In a known manner, a translation along a distance depending on the wear, in other words on the thickness, of the elements 2a, 2b is carried out between the contact position and the rest position.

Advantageously according to the invention, the clamping device 7 comprises a mechanism 19 for radial and/or tangential decoupling of the stop 11, intended to receive a friction element 2a, 2b with respect to a free end 17a of the screw 17 of the conversion mechanism 15 in order to improve the mechanical strength of the latter. Thus, the decoupling mechanism 19 allows the stop 11 to travel a predetermined distance, in other words preferably two degrees of freedom with respect to the end 17a of the screw 17 in order to limit the stresses likely to cause brinelling of the thread of the screw 17 and/or of the outer surface of at least one ball 18 and/or the tapping of the nut 16.

Thus, in the contact position of the friction elements 2a, 2b where the screw 17 of the conversion mechanism 15 projects fully out of the frame 8, any stress directed away from the axial direction A of the clamping-unclamping movement generates an eccentric moment along the entire length of screw 17 increasing said stress, by the lever arm phenomenon, of the end of the screw 17 closest to the electric actuator 12 against the balls 18 and the nut 16. This is all the more true when the friction elements 2a, 2b are highly worn when the translation distance is increased, thereby amplifying the lever arm phenomenon. The radial and in particular tangential stresses are caused by the friction elements 2a, 2b rubbing against the disc 3.

Advantageously according to the invention, the radial and/or tangential decoupling mechanism 15 decreases or even eliminates any lever arm phenomenon and compensates for any eccentric moment by displacement of the stop 11 with respect to the screw 17 so as to only transmit a negligible proportion of non-axial stresses to the balls 18 and to the nut 16 of the conversion mechanism 15. We therefore understand that the brinelling and more generally the deformation of the members of the conversion mechanism 15 are avoided to guarantee high robustness, in other words in particular to avoid having to replace the clamping device 7 during at least the lifetime of the vehicle 4.

The radial and/or tangential decoupling mechanism 19 comprises a connection element 21 and a flange 23. The element 21 preferably forms at least one connection of the cylindrical joint type between the stop 11 and the free end 17a of the screw 17 to limit the transmission, to the balls 18 of the conversion mechanism 15, of the radial and/or tangential stresses received by the stop 11.

We therefore understand that it is preferable to have one first degree of freedom in translation β, −β along a tangential direction T (perpendicular to the axial direction A as shown in particular on FIG. 10) and one degree of freedom in rotation α, −αa about the same tangential direction T (as shown in particular on FIG. 9) to allow to a certain extent the stop 11 to “follow” the radial and/or tangential stress direction of contact between the disc 3 and the friction element 2a, 2b by limiting the non-axial transmission of stresses to the conversion mechanism 15.

The cylindrical joint connection element 21 thus comprises an elongated body 21a having a substantially cylindrical shape intended to allow the stop 11 to pivot with respect to the free end 17a of the screw 17. As shown in the example of FIGS. 5-6 and 9-10, the body 21a comprises a first end 20 having a contact surface 20a intended to rest against the bottom 24c of a seat 24 of the stop 11. The contact surface 20a preferably has a partially spherical shape and the bottom 24c of the seat 24 of the stop 11 preferably has a partially cylindrical concave surface of circular section oriented to allow a tangential translation β, −β of the stop 11 with respect to the cylindrical joint connection element 21 but also in particular a rotation α, −α about the same tangential direction T as the translation. It is therefore this connection element 21 coupled to the stop 11 which will bear most of the non-axial stresses between the disc 3 and the friction element 2a, 2b.

To prevent a rotation about the radial direction and limit the tangential translation β,β and rotation α, −α, the first end 20 of the cylindrical joint connection element 21 is blocked in the seat 24 of the stop 11 by a flange 23. More precisely, the flange 23 comprises a generally annular body 23a having a central opening 23d which receives the body 21a of the connection element 21. The body 23a comprises a collar forming an attachment element 23e against the outer surface of the ring 11c formed by the annular recess 11b in the stop 11. We understand that the contact surface 20a is held against the bottom 24c of the seat 24 of the stop 11 by elastic interlocking of the inner diameter of the attachment element 23e against the outer diameter of the ring 11c.

Preferably, the decoupling mechanism 19 is arranged to allow a tangential translation β,β up to two millimetres of the stop 11 with respect to the cylindrical joint connection element 21, in other words the maximum possible travel (between β,β) of the connection element 21 along the tangential direction in the opening 23d of the flange 23 by the peripheral wall 20b abutting against respectively the elements 23c limiting the translation of the flange 23.

In addition, the decoupling mechanism 19 is arranged to allow a rotation α, −α about the tangential translation axis T up to two degrees of the stop 11 with respect to the cylindrical joint connection element 21, in other words the maximum possible angular travel (between α and −α) of the connection element 21 about the tangential direction T in the opening 23d of the flange 23 by the rear surface 20c abutting against respectively the elements 23b limiting the rotation of the flange 23. Note also that the complementary shapes of the rear surface 20c and the elements 23b limiting the rotation limit or even prevent the radial rotation and the axial and radial translations of the stop 11 with respect to the connection element 21, which favours the tangential translation β,β.

Lastly, to prevent the relative rotation between the stop 11 and the cylindrical joint connection element 21 about the axial direction A, the inner wall 24a, 24b of the seat 24 of the stop 11 is asymmetrical and has a shape complementary to the peripheral wall 20b of the first end 20 of the cylindrical joint connection element 21. In the example shown on FIGS. 5-6 and 9-10, the inner wall comprises at least one part 24a (two parallel parts 24a shown on FIG. 5) forming a tangential direction flat, in other words a plane surface, having a shape complementary to a flat of the peripheral wall 20b of the connection element 21 in order to prevent any rotation about the axial clamping/unclamping direction A.

In the example shown on FIG. 5, the two parallel parts 24a are connected together laterally by circular arc-shaped parts 24b to form an inner wall of the seat 24 which extends around the bottom 24c. The circular arc-shaped parts 24b do not necessarily have to have a shape that is complementary to the peripheral wall 20b of the connection element 21 since they are not intended to come into contact with them, it is the elements 23c limiting the translation of the flange 23 which have this function as suggested on FIG. 10. Obviously, a polygonal section of the inner wall of the seat 24 having a shape corresponding to that of the peripheral wall 20b of the first end 20 would produce a similar effect.

As shown in the example of FIGS. 5-7 and 9-10, the body 21a comprises a second end 22 intended to be interlocked with clearance fit in the free end 17a of the screw 17. More precisely, the contact surface 22a and the peripheral wall 22b of the second end 22 preferably have shapes respectively complementary to the bottom 17c and the inner wall 17b of the free end 17a of the screw 17 to prevent the relative rotation between the free end 17a of the screw 17 and the cylindrical joint connection element 21 about the axial direction but allow relative tangential γ,−γ and radial δ, −δ rotations between the connection element 21 and the screw 17 in order in particular to be able to “follow” the movements of the cylindrical joint connection of the first end 20.

In the example shown on FIGS. 5-7 and 9-10, the contact surface 22a and the bottom 17c have partially spherical complementary shapes, respectively convex and concave in order to allow to a certain extent, due to the interlocking with clearance fits, relative tangential γ, −γ and radial δ, −δ rotations between the connection element 21 and the screw 17. The decoupling mechanism 19 is arranged to allow relative tangential γ, −γ and radial δ, −δ rotations between the connection element 21 and the screw 17 up to two degrees, in other words the maximum possible angular travel (between γ and −γ and between δ and −δ) of the connection element 21 respectively about the tangential direction T and the radial direction R by the peripheral wall 22b of the connection element 21 abutting against the inner wall 17b of the free end 17a of the screw 17.

In addition, the sections of the peripheral wall 22b of the second end 22 and of the inner wall 17b of the free end 17a of the screw 17 have asymmetrical complementary shapes to prevent the relative rotation between the free end 17a of the screw 17 and the cylindrical joint connection element 21 about the axial direction A. In the example shown on FIGS. 5-7 and 9-10, the sections of the peripheral wall 22b of the second end 22 and of the inner wall 17b of the free end 17a of the screw 17 are polygonal (octagonal on FIGS. 5 and 7). Obviously, an elliptical section of the inner wall 17b of the free end 17a of the screw 17 having a shape complementary to that of the peripheral wall 22b of the second end 22 produces a similar effect.

The invention is not limited to the embodiments and variants described and other embodiments and variants will be clearly apparent to those skilled in the art. Thus, the embodiments and variants can be combined together without departing from the scope of the invention. As a non-limiting example, other geometries of the connection element 21 and/or of the seat 24 and/or of the interlocking between the free end 17a of the screw 17 and the connection element 21 are possible, the cylindrical joint connection could even be switched with the connection by interlocking with clearance fit without departing from the scope of the invention.

### LIST OF REFERENCES

1—braking system
2a—friction element
2b—friction element
3—disc
4—vehicle
5—wheel
8—frame
9—carrier
10—calliper
11—stop
11a—groove
11b—annular recess
11c—attachment ring
12—electric actuator
13—output shaft
14—reduction gear
15—conversion mechanism
16—nut
17—screw
17a—free end of screw
17b—inner wall of the free end of screw
17c—bottom of the free end of screw
18—balls
19—radial and/or tangential decoupling mechanism
20—first end of the connection element
20a—contact surface of the first end
20b—peripheral wall of the first end
20c—rear surface of the first end
21—connection element
21a—body of the connection element
22—second end of the connection element
22a—contact surface of the second end
22b—peripheral wall of the second end
23—flange
23a—body of the flange
23b—element limiting the rotation of the flange
23c—element limiting the translation of the flange
23d—opening of the flange
23e—attachment element of the flange
24—seat of the stop
24a—part of the inner wall forming a tangential direction flat
24b—circular arc-shaped part of the inner wall
24c—bottom of the seat of the stop
α—relative tangential rotation between the connection element and the stop
β—relative tangential translation between the connection element and the stop
γ—relative tangential rotation between the connection element and the screw
δ—relative radial rotation between the connection element and the stop

1. A clamping device for a braking system configured to exert a relative displacement between friction elements comprising a frame supporting an electric actuator configured to supply a clamping force and a conversion mechanism for converting rotational movement of an output shaft of the electric actuator into a translational movement which is coupled to the electric actuator to allow the relative displacement movement between the friction elements along an axial rectilinear direction, wherein the conversion mechanism is a ball-screw type mechanism having a nut coupled to a screw by balls, and wherein the clamping device comprises a decoupling mechanism for radial and/or tangential decoupling of a stop configured to receive a friction element with respect to a free end of the screw of the conversion mechanism in order to improve the a mechanical strength of the conversion mechanism.

2. The clamping device according to claim 1, wherein the decoupling mechanism comprises a cylindrical joint connection element between the stop and the free end of the screw to limit transmission, to the balls of the conversion mechanism, of radial and/or tangential stresses received by the stop.

3. The clamping device according to claim 2, wherein the cylindrical joint connection element comprises a body having a first end which cooperates with a seat of the stop and having a second end which is interlocked with clearance fit in the free end of the screw.

4. The clamping device according to claim 3, wherein the first end of the cylindrical joint connection element has a partially spherical contact surface configured to rest against the a bottom of the seat of the stop the bottom having a partially cylindrical concave surface of circular section oriented to allow a tangential translation of the stop with respect to the cylindrical joint connection element.

5. The clamping device according to claim 4, wherein the first end of the cylindrical joint connection element is blocked in the seat of the stop using a flange in order to limit travel of the tangential translation of the stop with respect to the cylindrical joint connection element and the rotation about a tangential translation axis of the stop with respect to the cylindrical joint connection element.

6. The clamping device according to claim 5, wherein the decoupling mechanism is arranged to allow a tangential translation up to two millimetres of the stop with respect to the cylindrical joint connection element and a rotation about the tangential translation axis up to two degrees of the stop with respect to the cylindrical joint connection element.

7. The clamping device according to claim 6, wherein an inner wall of the seat of the stop is asymmetrical and has a shape complementary to a peripheral wall of the first end of the cylindrical joint connection element to prevent the relative rotation between the stop and the cylindrical joint connection element about the axial direction.

8. The clamping device according to claim 7, wherein the interlocking between the second end of the cylindrical joint connection element and the free end of the screw has a complementary shape to prevent the relative rotation between the free end of the screw and the cylindrical joint connection element about the axial direction.

9. A braking system for a vehicle comprising a pair of the friction elements intended configured to cooperate by friction with a disc, comprising at least one clamping device according to claim to move the pair of the friction elements towards two opposite sides of the disc in order to clamp it.

10. The braking system according to claim 9, being floating calliper disc brake type braking system.

11. A vehicle, comprising that it comprises at least one braking system according to claim 10.

12. A vehicle, comprising at least one braking system according to claim 9.

13. The clamping device according to claim 3, wherein an inner wall of the seat of the stop is asymmetrical and has a shape complementary to a peripheral wall of the first end of the cylindrical joint connection element to prevent the relative rotation between the stop and the cylindrical joint connection element about the axial direction.

14. The clamping device according to claim 3, wherein the interlocking between the second end of the cylindrical joint connection element and the free end of the screw has a complementary shape to prevent the relative rotation between the free end of the screw and the cylindrical joint connection element about the axial direction.
